(19) United States
(12) Patent Application Publication
(10) Pub. No.: US 2006/0050425 A1
(43) Pub. Date: Mar. 9, 2006

(54) Laminated glass

(75) Inventors: Takashi Muromachi, Tokyo (JP); Tatsuya Noguchi, Tokyo (JP)

Correspondence Address: MERCHANT & GOULD PC, P.O. BOX 2903, MINNEAPOLIS, MN, 55402-0903, US

(73) Assignee: Nippon Sheet Glass Company, Limited, Tokyo (JP)

(21) Appl. No.: 10/514,377

(22) PCT Filed: Jun. 23, 2003
(86) PCT No.: PCT/JP03/07948

§ 371 Date: Nov. 12, 2004

(30) Foreign Application Priority Data
Jun. 24, 2002 (JP) 2002-183616

(51) Int. Cl. G02B 5/08; G02B 7/182

(52) U.S. Cl. 359/883

(57) ABSTRACT

To achieve an excellent solar radiation shielding properties and a visible light reflectance of at least 70%, the interlayer portion of the laminated glass of the present invention includes a heat reflecting film and a film having a heat shielding function that is provided between the heat reflecting film and the second glass sheet. The heat reflecting film may be an optical interference multilayer film obtained by laminating layers of two types of polymer thin films having different refractive indices. The film having the heat shielding function can contain fine particles of at least one selected from hexaboride and ITO. The laminated glass can be bent to have a convex surface and a concave surface. In this laminated glass, the convex surface is formed by the first glass sheet and the concave surface is formed by the second glass sheet.

### FIELD OF THE INVENTION

The invention relates to a laminated glass used as window glass in buildings and vehicles such as automobiles, and more particularly relates to a heat insulating laminated glass that includes a heat reflecting film.

### BACKGROUND OF THE INVENTION

The main points of a presentation regarding a “solar reflecting film that does not include metal” have been reported in Gakujutsu Koenkai Zensatsu-shu, No. 96-00, pages 17 to 21”, published by the Society of Automotive Engineers of Japan, Inc. Therein, a laminated glass using a solar (heat) reflecting film made of a polymer that does not include metal is disclosed. The structure of the laminated glass is glass sheet/PVB1/SRF/PVB2/glass sheet (PVB: polyvinyl butyral, SRF: solar reflecting film). The properties thereof were reported as shown in Table 1 below.

TABLE 1

| Glass Sheet Configuration | Tv (%) | Te (%) | Re (%) |
|---|---|---|---|
| clear/green | 78 | 48 | 22 |
| green/green | 73 | 41 | 10 |

Tv: Visible Light Transmittance,
Te: Solar Radiation Transmittance
Re: Solar Radiation Reflectance

JP 2001-151539A discloses “A laminated glass having a plurality of glass sheets and an interlayer in which infrared shielding fine particles having a particle diameter of not more than 0.2 μm are dispersed, said interlayer interposed between said plurality of glass sheets, wherein at least one glass sheet of said plurality of glass sheets is made of soda-lime silica glass containing a total iron content of 0.3% to 1% mass in terms of Fe₂O₃.”

With the laminated glass using the above solar reflecting film, there was the problem that the ability to shield solar radiation was insufficient, as the solar radiation transmittance (Te) of the laminated glass as a whole exceeded 40%, as shown in Table 1.

Moreover, in the laminated glass disclosed in JP 2001-151539A, a large amount of heat is absorbed by the glass sheets and the interlayer, and thus there was the problem that the amount of absorbed thermal energy that is radiated into the interior of the vehicle was large.

These problems will be described taking the first embodiment set forth in JP 2001-151539A as an example. When the interlayer disclosed here is used, the solar radiation transmittance of the laminated glass exhibits a value of 46.5%. However, this reduction in the solar radiation transmittance is due to the ability of the interlayer to absorb thermal radiation, and several tens of percent of the thermal energy absorbed by the interlayer is re-radiated into the interior of the vehicle. For the laminated glass using an ordinary interlayer, the percentage of radiation into the interior of the vehicle due to re-radiation is about 14%, whereas in the above-mentioned first embodiment it is 17%, indicating that a larger percentage is radiated into the vehicle.

### DISCLOSURE OF THE INVENTION

A laminated glass of the present invention includes a first glass sheet, an interlayer portion, and a second glass sheet, and the interlayer portion includes a heat reflecting film and a film having a heat shielding function that is provided between the heat reflecting film and the second glass sheet. The heat reflecting film is an optical interference multilayer film obtained by laminating layers of two types of polymer thin films having different refractive indices. This laminated glass can have a visible light transmittance of at least 70%.

### BRIEF DESCRIPTION OF THE DRAWINGS

FIG. 1 shows an example of a basic configuration of the insulating laminated glass according to the invention.

FIG. 2 shows another example of the basic configuration of the insulating laminated glass according to the invention.

FIG. 3 is a graph showing the transmission spectrum of the insulating laminated glass.

FIG. 4 is a graph showing the transmission spectrum of the insulating laminated glass.

### DETAILED DESCRIPTION OF THE INVENTION

In one embodiment of the laminated glass according to the present invention, the interlayer portion includes a first thermoplastic resin interlayer, the heat reflecting film, and a second thermoplastic resin interlayer. The film having the solar shielding function is the second thermoplastic resin interlayer. In this second thermoplastic resin interlayer, functional fine particles with a particle size of not more than 0.2 μm and having the heat shielding function may be dispersed. It is preferable that the fine particles include at least one selected from indium tin oxide (ITO) and hexaboride.

In another embodiment of the laminated glass, the interlayer portion includes a first thermoplastic resin interlayer, the heat reflecting film, and a second thermoplastic resin interlayer, and the film having the heat shielding function is formed between the second thermoplastic resin interlayer and the second glass sheet. In this case, the film having the heat shielding function may be an application film containing fine particles of at least one selected from hexaboride and ITO with a particle size of not more than 0.2 μm. It is preferable that this film is an ITO thin film.

The second thermoplastic resin interlayer may include the functional fine particles. If this resin interlayer is free of functional fine particles and does not have a heat shielding function, another film (a film having a heat shielding function) should be added. This film may be used with the second thermoplastic resin interlayer that has a heat shielding function.

In the laminated glass, the heat absorption of the first glass sheet can be equal to or smaller than that of the second glass sheet, and heat absorption of the first glass sheet is preferably smaller than that of the second glass sheet. The combination of the first glass sheet and the second glass sheet of the laminated glass may be any one of clear/green, clear/ultraviolet-absorbing green, green/green, green/ultraviolet-absorbing green, and ultraviolet-absorbing green/ultraviolet-absorbing green, in that order.

The laminated glass may be bent and have a convex surface and a concave surface. The convex surface can be formed by the first glass sheet and the concave surface can be formed by the second glass sheet. This laminated glass is suitable for a window opening of a vehicle body. The first glass sheet should be arranged on an exterior side of the vehicle and the second glass sheet should be arranged on an interior side of the vehicle. The present invention also can provide such a window structure.

In the laminated glass according to the invention, the interlayer portion may have a structure in which a heat reflecting film is sandwiched between two thermoplastic resin interlayers.

With the laminated glass, the infiltration of solar energy into the interior of the vehicle is prevented by reflecting irradiated sunlight energy to the exterior side of the vehicle to some extent by using a reflecting film.

Here, the balance of the solar energy irradiated onto the window glass of a vehicle is examined. An ordinary single-pane float glass (5 mm) serves as an example in the following description. When the irradiated solar energy is regarded as 100, then of that 100, 82.3 parts are transmitted, 7.4 parts are reflected, and the remaining 10.3 parts are absorbed by the glass sheet. Of the energy of the 10.3 parts that are absorbed, 3.7 parts are radiated into the interior of the vehicle.

With only a heat reflecting film, the insulating capabilities are insufficient due to the re-radiation. When the single interlayer is given a heat shielding function, the amount of solar energy absorbed by the laminated glass increases, and as a consequence the amount of energy that is radiated into the interior of the vehicle increases as well.

To prevent solar energy as a whole from entering into the vehicle, it is necessary for the laminated glass to inhibit the energy that is transmitted while also reducing the energy that is temporarily absorbed by the glass and then re-radiated to the interior side of the vehicle.

Accordingly, in the present invention, the energy from sunlight is reflected by the heat reflecting film and heat radiation further is shielded by, for example, an interlayer and/or an application film having a heat shielding function.

The present invention can provide a laminated glass in which the member on one side (the exterior side of the vehicle) with respect to the heat reflecting film is made of a material with a smaller solar absorption, in order for the heat reflecting film to reflect as much solar energy as possible.

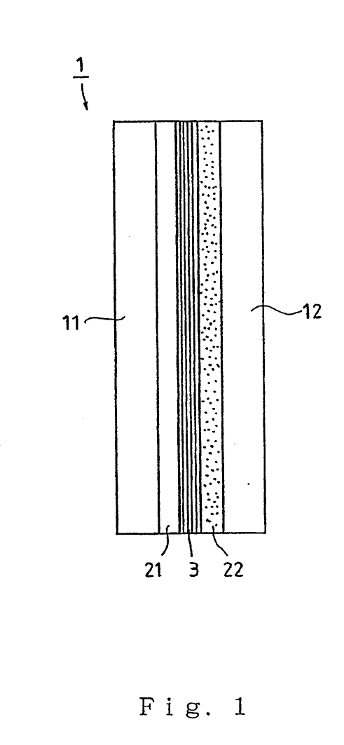

In other words, as shown in FIG. 1, with the heat reflecting film 3 serving as a boundary, the constituent members 11, 21 on one side (the vehicle exterior side) of the laminated glass 1 have heat absorption that is equal to or less than that of the constituent members 12, 22 on the other side (the vehicle interior side) of the laminated glass 1.

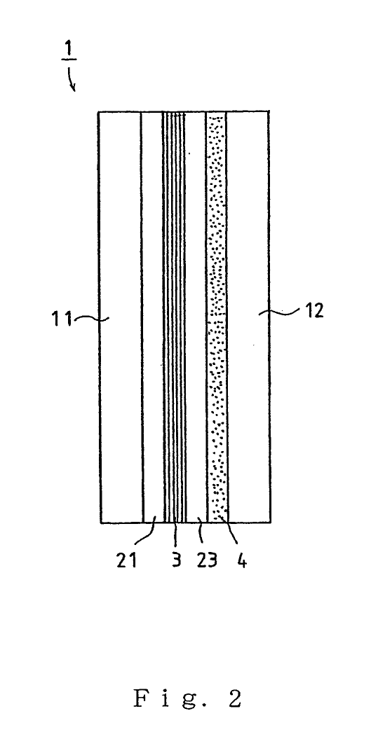

Specifically, in the glass sheets making up the laminated glass 1, the heat absorption of the first glass sheet 11 should be equal to or smaller than that of the second glass sheet 12. In the interlayer portion, the first thermoplastic resin interlayer 21 may be an ordinary interlayer and the second thermoplastic resin interlayer 22 may have functional fine particles such as ITO fine particles dispersed therein so as to increase its heat absorption. As shown in FIG. 2, an application film 4 containing ITO fine particles or the like can be provided between the second thermoplastic resin interlayer 23 and the second glass sheet 12 so as to increase the heat absorption. In this case, the second thermoplastic resin interlayer 23 may be an ordinary interlayer that is free from functional fine particles.

Examples of materials with large heat absorption include interlayers and application films in which functional fine particles, pigments having the ability to absorb solar energy or ink containing heat absorption agents are dispersed or contained. Furthermore, there is no limitation to these examples, and it is sufficient if the material absorbs solar energy and can be formed sandwiched in a laminated glass.

The inventors found that even in a laminated glass made by laminating several such members, the order in which they are laminated results in differences in the amount of sunlight energy that enters into the interior of the vehicle.

As a vehicle window glass, the interlayer or the application film cannot be given too large a heat absorption ability if a predetermined visible light transmittance, such as 70% or 75%, is to be secured. From this standpoint as well, there is practical usefulness in the fact that the sunlight energy that enters into the interior of the vehicle can be limited even further by regulating the order in which the laminated glass is formed.

The heat reflecting film preferably does not include metal and more preferably is made entirely of polymers. The film can be an optical interference multilayer film in which multiple layers of two types of polymer thin films with different refractive indices are formed in alternation, and is specifically a film that is formed by layering multiple layers of polyethylene naphthalate (PEN) and poly(methyl methacrylate) (PMMA) in alternation, so as to employ optical interference to reflect thermal energy (for example, see U.S. Pat. No. 6,049,419).

The heat shielding interlayer of the present invention preferably contains heat shielding fine particles of hexaboride fine particles and/or ITO fine particles. Representative examples of a hexaboride material include fine particles of lanthanum hexaboride (LaB₆), cerium hexaboride (CeB₆), praseodymium hexaboride (PrB₆), neodymium hexaboride (NdB₆), gadolinium hexaboride (GdB₆), or fine particles of mixtures thereof.

The per unit mass ability of hexaboride material to shield sunlight is extremely high, exhibiting effects equal to those of ITO at a tenth of the amount. Thus, hexaboride material allows the amount of fine particles mixed with the interlayer to be reduced. Consequently, the laminated glass can maintain a constant visible light transmittance while its ability to shield out sunlight is increased. A reduction in cost also is achieved.

It should be noted that the heat insulating laminated glass according to the present invention is not limited to vehicles, and also can be adopted for buildings, in which case the first glass sheet of the laminated glass should be arranged on the exterior side of the building and the second glass sheet should be arranged on the interior side of the building.

### EXAMPLES

### Working Example 1

### Clear Glass Sheet/Ultraviolet-Absorbing Green Glass Sheet Combination

ITO fine particles were used as heat shielding fine particles. Polyvinyl butyral (PVB) was mixed into a liquid of ITO fine particles dispersed in a plasticizer (triethylene glycol-di-2-ethylbutyrate) to prepare a vinyl-based resin composition. This vinyl-based resin composition was kneaded with a roller to fabricate a sheet-shaped heat absorbing interlayer with a thickness of 0.76 mm. It should be noted that at this time the content of the ITO fine particles was 0.7 mass percent of the entire resin composition.

On a first glass sheet (thickness: 2.1 mm) serving as the vehicle exterior side glass sheet were stacked an ordinary first interlayer (a PVB interlayer that is free from ITO fine particles; 0.38 mm), a heat reflecting film, a second interlayer (the heat absorbing interlayer with ITO fine particles dispersed therein), and a second glass sheet (2.1 mm) serving as the vehicle interior side glass sheet. After provisionally adhering these to one another, they were permanently adhered in an autoclave under 140° C. and 14 kg/cm², fabricating the heat insulating laminated glass.

It should be noted that with regard to the structure of the glass sheets, the glass sheet on the vehicle exterior side is a clear glass sheet and the glass sheet on the vehicle interior side is an ultraviolet-absorbing green glass sheet (see Table 2). The properties of the heat insulating laminated glass that was obtained were measured, and it was found that sufficient solar radiation shielding capabilities were obtained (see Table 3).

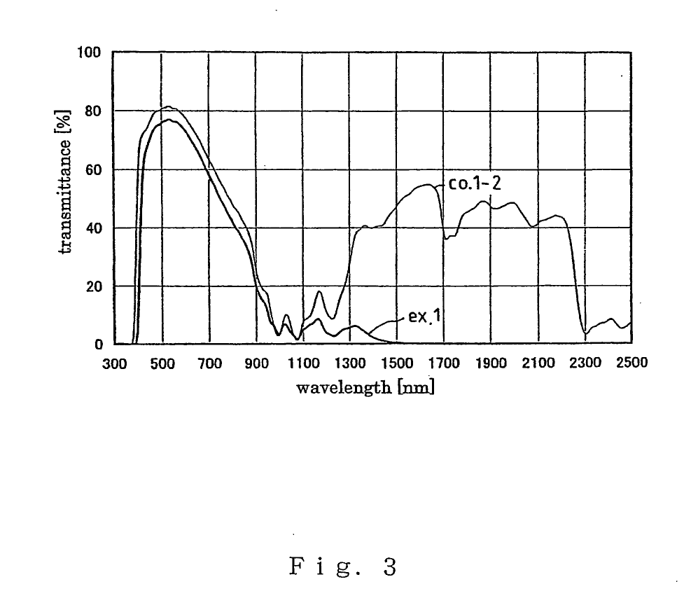

FIG. 3 shows the transmission spectrum in Working Example 1. In Working Example 1, it was found that excellent heat shielding properties were obtained with hardly any decrease in the ability to transmit light in the visible spectrum and with a significant drop in the ability to transmit wavelengths longer than near-infrared.

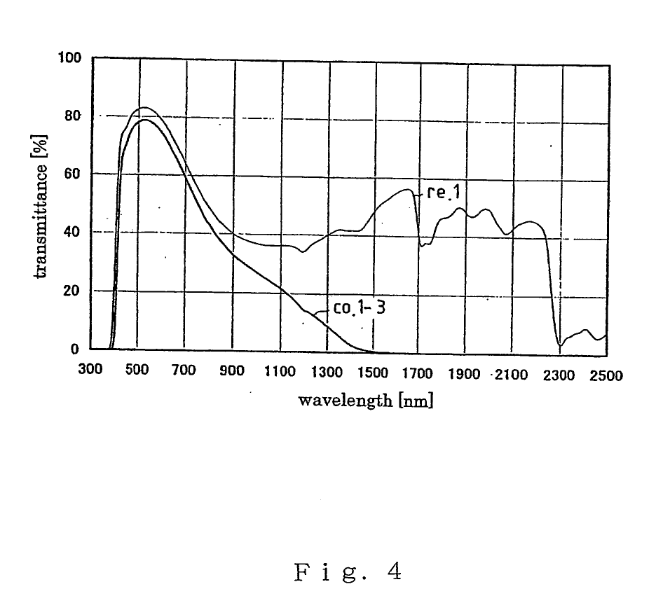

Also, as is clear from the graph of FIG. 3, with the heat insulating laminated glass having this configuration, the transmittance at a wavelength of 850 nm, for example, is equal to that of ordinary green laminated glass (see FIG. 4), and there are no problems with regard to the transmission of light at specific wavelengths due to the use of an interlayer in which ITO fine particles have been dispersed. More specifically, it was confirmed that there was no interference with the reception of the light beacon or other optical sensors.

### Comparative Example 1-1

A heat insulating laminated glass was fabricated in the same manner as in the above-described Working Example 1 except that the order in which the first interlayer and the second interlayer were layered was reversed. In other words, the interlayer in which ITO fine particles were dispersed is arranged on the exterior side of the vehicle with respect to the heat reflecting film.

The results are shown in Table 3. With respect to the sunlight transmittance, it was found that this heat insulating laminated glass exhibits a performance that is on par with Working Example 1, however, there is less sunlight reflectance than in Working Example 1, leading to a larger amount of solar energy entering into the interior of the vehicle (a larger solar radiation heat acquisition rate).

### Comparative Example 1-2

A heat insulating laminated glass was prepared in the same manner as in Working Example 1 except that no heat absorbing interlayer was used.

The results are shown in Table 3. The solar radiation transmittance was 48.7%, indicating that the obtained laminated glass did not have solar radiation shielding properties.

### Comparative Example 1-3

A heat insulating laminated glass was prepared in the same manner as in Working Example 1 except that no heat reflecting film was used.

The results are shown in Table 3. The solar radiation transmittance was 42.7%, indicating that the obtained laminated glass did not have sufficient solar radiation shielding properties. Also, in this case, the lack of a heat reflecting film resulted in less sunlight reflectance, thereby increasing the amount of solar heat that is acquired.

### Reference Example 1

A laminated glass was obtained by adhering a clear glass sheet and an ultraviolet-absorbing green glass sheet using an ordinary interlayer to serve as Reference Example 1. This laminated glass was measured, and the results are also shown in Table 3.

It should be noted that FIG. 3 shows a graph of the transmittance curve of Working Example 1 (ex. 1) and the Comparative Example 1-2 (co. 1-2) and FIG. 4 shows a graph of the transmittance curve of the Comparative Example 1-3 (co. 1-3) and the first Reference Example (re. 1).

From FIG. 3, it can be seen that the Comparative Example 1-2 has a greater transmittance of light in the wavelength region of approximately 1100 nm and higher than Working Example 1, and from this it is clear that Comparative Example 1-2 has poorer solar radiation shielding properties. From FIGS. 3 and 4, it can be seen that the Comparative Example 1-3 has a greater transmittance of light in the wavelength region of approximately 900 to 1300 nm than Working Example 1, and from this it is clear that Comparative Example 1-3 has poorer solar radiation shielding properties.

TABLE 2

| | Glass | Interlayer | Reflecting | Interlayer | Glass |
|---|---|---|---|---|---|
| | Sheet 1 | 1 | Film | 2 | Sheet 2 |
| Working Ex. 1 | clear | clear | yes | heat | UV green |
| | | | | absorbing | |
| Comp. Ex. 1-1 | clear | heat | yes | clear | UV green |
| | | absorbing | | | |
| Comp. Ex. 1-2 | clear | clear | yes | clear | UV green |
| Comp. Ex. 1-3 | clear | clear | no | heat | UV green |
| | | | | absorbing | |
| Ref. Ex. 1 | clear | clear | no | clear | UV green |

UV green: ultraviolet-absorbing green glass

TABLE 3

| | Visible | Solar | Solar | | Visible |
|---|---|---|---|---|---|
| | Light | Radiation | Radiation | Sunlight | Light |
| | Trans- | Trans- | Heat | Reflec- | Reflec- |
| | mittance | mittance | Acquisition | tance | tance |
| | Tv (%) | Te (%) | Rate η (%) | Re (%) | Rv (%) |
| Working Ex. 1 | 74.4 | 38.0 | 53.6 | 18.1 | 7.9 |
| Comp. Ex. 1-1 | 74.4 | 38.1 | 56.2 | 10.8 | 8.0 |
| Comp. Ex. 1-2 | 78.9 | 48.7 | 60.2 | 18.7 | 8.2 |
| Comp. Ex. 1-3 | 75.9 | 42.7 | 61.1 | 5.6 | 7.2 |
| Ref Ex. 1 | 80.2 | 55.3 | 69.1 | 6.0 | 7.4 |

### Working Example 2

### Green Glass Sheet/Green Glass Sheet Combination

A heat insulating laminated glass was fabricated in the same manner as in Working Example 1 except that the configuration of the glass sheets was altered by substituting a green glass sheet (2.1 mm) for the glass sheet on the exterior side of the vehicle and a green glass sheet (2.1 mm) for the glass sheet on the interior side of the vehicle (see Table 4).

The results are shown in Table 5. The solar radiation transmittance was less than 40%, indicating that sufficient sunlight shielding properties were obtained. The sunlight reflectance was high at 11.1%, demonstrating a large sunlight reflectance, and the amount of solar heat that is absorbed, that is, the total amount of heat that infiltrates into the interior of the vehicle, was low at 54.6%, indicating that this insulating laminated glass has excellent solar radiation shielding properties.

### Comparative Example 2

A heat insulating laminated glass was fabricated in the same manner as in Comparative Example 1-2 except that the configuration of the glass sheets was altered by substituting a green glass sheet (2.1 mm) for the glass sheet on the exterior side of the vehicle and a green glass sheet (2.1 mm) for the glass sheet on the interior side of the vehicle.

The results are shown in Table 5. The solar radiation transmittance was 45.4%, indicating that this laminated glass did not exhibit sufficient solar radiation shielding properties.

### Reference Example 2

A laminated glass was obtained by adhering a green glass sheet and a green glass sheet using an ordinary interlayer to serve as a Reference Example 2. This laminated glass was measured, and the results also are shown in Table 5.

TABLE 4

| | Glass | Interlayer | Reflecting | Interlayer | Glass |
|---|---|---|---|---|---|
| | Sheet 1 | 1 | Film | 2 | Sheet 2 |
| Working | green | clear | yes | heat | green |
| Ex. 2 | | | | absorbing | |
| Comp. | green | clear | yes | clear | green |
| Ex. 2 | | | | | |
| Ref. Ex. 2 | green | clear | no | clear | green |

TABLE 5

| | Tv (%) | Te (%) | η (%) | Re (%) | Rv (%) |
|---|---|---|---|---|---|
| Working Ex. 2 | 72.7 | 35.9 | 54.6 | 11.1 | 7.8 |
| Comp. Ex. 2 | 77.2 | 45.4 | 60.6 | 11.5 | 8.1 |
| Ref. Ex. 2 | 78.5 | 51.0 | 66.3 | 5.8 | 7.2 |

### Working Example 3

### Green Glass Sheet/Ultraviolet-Absorbing Green Glass Sheet Combination

A heat insulating laminated glass was fabricated in the same manner as in Working Example 1 except that the configuration of the glass sheets was altered by substituting a green glass sheet (2.1 mm) for the glass sheet on the exterior side of the vehicle (see Table 6).

The results are shown in Table 7. The solar radiation transmittance was less than 40%, indicating that sufficient solar radiation shielding properties were obtained. The solar radiation reflectance was high at 11.1%, demonstrating a large solar radiation reflectance, and the amount of solar heat that is absorbed, that is, the total amount of heat that infiltrates into the interior of the vehicle, was low at 53.2%, indicating that this insulating laminated glass has excellent solar radiation shielding properties.

### Comparative Example 3

A heat insulating laminated glass was fabricated in the same manner as in Comparative Example 1-3 except that the configuration of the glass sheets was altered by substituting a green glass sheet (2.1 mm) for the glass sheet on the exterior side of the vehicle and an ultraviolet-absorbing green glass sheet (2.1 mm) for the glass sheet on the interior side of the vehicle.

The results are shown in Table 7. The laminated glass had good solar radiation shielding properties with a sunlight transmittance of less than 40%, however, the solar radiation reflectance was small because a solar reflecting film was not used, resulting in a larger percentage of solar heat absorbed than in Working Example 3.

### Reference Example 3

As Reference Example 3, a laminated glass was obtained by adhering a green glass sheet and an ultraviolet-absorbing green glass sheet using an ordinary interlayer. This laminated glass was measured, and the results also are shown in Table 7.

TABLE 6

| | Glass | Interlayer | Reflecting | Interlayer | Glass |
|---|---|---|---|---|---|
| | Sheet 1 | 1 | Film | 2 | Sheet 2 |
| Working | green | clear | yes | heat | UV green |
| Ex. 3 | | | | absorbing | |
| Comp. Ex. 3 | green | clear | no | heat | UV green |
| | | | | absorbing | |
| Ref. Ex. 3 | green | clear | no | clear | UV green |
| Working | clear | clear | yes | heat | UV green |
| Ex. 4 | | | | absorbing | |
| Working | clear | clear | yes | Clear * | UV green |
| Ex. 5 | | | | | |

* with heat absorbing application film

TABLE 7

| | Tv (%) | Te (%) | η (%) | Re (%) | Rv (%) |
|---|---|---|---|---|---|
| Working Ex. 3 | 70.1 | 33.7 | 53.2 | 11.0 | 7.7 |
| Comp. Ex. 3 | 71.5 | 36.8 | 57.2 | 5.4 | 6.9 |
| Ref. Ex. 3 | 76.0 | 46.7 | 63.5 | 5.7 | 7.2 |
| Working Ex. 4 | 73.5 | 39.2 | 53.8 | 18.2 | 7.8 |
| Working Ex. 5 | 71.5 | 38.2 | 53.2 | 18.0 | 7.8 |

### Working Example 4

### Second Interlayer with ITO Fine Particles and LaB₆ Fine Particles Dispersed Therein

A sheet-shaped interlayer was fabricated at a thickness of 0.76 mm in the same manner as in Working Example 1 using a mixture of ITO fine particles and LaB₆ fine particles as the solar shielding fine particles. The mass ratio of ITO to LaB₆ fine particles was set to 98:2, and the mass percent of the content of the solar shielding fine particles (total mass of the ITO and LaB₆ fine particles) with respect to the total mass of the interlayer film was 0.14%. With this interlayer film serving as the second interlayer, an insulating laminated glass was obtained in the same manner as in Working Example 1 by arranging a clear glass sheet (2.1 mm) on the exterior side of the vehicle and an ultraviolet absorbing green glass sheet (2.1 mm) on the interior side of the vehicle.

The properties of the insulating laminated glass of Working Example 4 were measured, and it was found that sufficient solar shielding capabilities were obtained (see Table 7).

### Working Example 5

### Formation of a Solar Absorbing Application Film

20 g of LaB₆ fine particles having an average particle diameter of 67 nm, 50 g of diacetone alcohol (DAA), 20 g of triethylene glycol-di-2-ethylbutyrate, and suitable quantities of water and a dispersing agent were mixed together and then mixed in a ball mill for 100 hours using zirconia balls having a diameter of 4 mm to prepare 100 g of liquid in which LaB₆ fine particles are dispersed (liquid A).

20 g of ITO fine particles having an average particle diameter of 80 nm, 70 g of triethylene glycol-di-2-ethylbutyrate, and suitable quantities of water and a dispersing agent were mixed together and then mixed in a ball mill for 100 hours using zirconia balls having a diameter of 4 mm to prepare 100 g of liquid in which ITO fine particles are dispersed (liquid B).

50 g of an ethyl silicate liquid mixture was prepared by thoroughly mixing and stirring an ethyl silicate solution prepared using 10 g of ethyl silicate 40 (made by Colcoat Co., Ltd.), which has an average degree of polymerization of four or five monomers, 27 g of ethanol, 8 g of an aqueous solution of 5% hydrochloric acid, and 5 g of water (liquid C).

These liquids A, B, and C were mixed and further diluted with diacetone alcohol to obtain an application liquid for forming a heat absorbing application film having an ITO concentration of 7.25 mass percent, a LaB₆ concentration of 0.045 mass percent, and a SiO₂ concentration of 2.25 mass percent. This application liquid was used to coat the inner surface of the glass sheet for the interior side of the vehicle, which then was placed in an electric furnace at 200° C. and heated for 30 minutes, forming a heat absorbing application film.

A glass sheet (2.1 mm) for the vehicle exterior side, an ordinary interlayer (0.38 mm), a heat reflecting film, an ordinary interlayer (0.38 mm), and a glass sheet (2.1 mm) for the vehicle interior side were stacked on one another such that the surface on which the application film is formed becomes the surface on the interior side of the vehicle. These were provisionally adhered to one another and then permanently adhered in an autoclave under 140° C. and 14 kg/cm² to fabricate an insulating laminated glass. It should be noted that a clear glass sheet (2.1 mm) was arranged on the vehicle exterior side and an ultraviolet absorbing green glass sheet (2.1 mm) was arranged on the interior side of the vehicle (see Table 6).

The results are shown in Table 7. The solar radiation transmittance was low at less than 40%, indicating that sufficient solar radiation shielding properties were obtained. The solar radiation reflectance was high at 18.0%, indicating large sunlight reflectance properties, and the percentage of solar heat that is absorbed, that is, the total amount of heat that infiltrates into the interior of the vehicle, was low at 53.2%, indicating that the heat insulating laminated glass had excellent sunlight shielding properties.

As described in the foregoing, the heat insulating laminated glass according to the present invention provides excellent solar radiation shielding properties while keeping a visible light transmittance of at least 70%.

First, with this configuration, the infiltration of solar energy into the interior of the vehicle is prevented by reflecting as much irradiated solar energy as possible to the exterior side of the vehicle by using a reflecting film. Furthermore, this configuration also allows the energy of the sunlight after reflection to be shielded by an interlayer, an ITO film, or an ITO containing application film having a solar energy shielding function, curbing the amount of energy that is radiated into the interior of the vehicle.

Moreover, this invention allows the solar energy that infiltrates into the interior of the vehicle to be kept down, because, with the reflecting film serving as a boundary, the glass sheet on the exterior side of the vehicle of the laminated glass is made of a material that has a smaller solar absorption capability than the glass sheet on the interior side of the vehicle.

1. A laminated glass comprising a first glass sheet, an interlayer portion, and a second glass sheet,
wherein the interlayer portion comprises a heat reflecting film and a film having a heat shielding function that is provided between the heat reflecting film and the second glass sheet;
wherein the heat reflecting film is an optical interference multilayer film obtained by laminating layers of two types of polymer thin films having different refractive indices; and
wherein said laminated glass has a visible light transmittance of at least 70%.

2. The laminated glass according to claim 1,
wherein the interlayer portion comprises a first thermoplastic resin interlayer, the heat reflecting film, and a second thermoplastic resin interlayer; and
wherein the film having the heat shielding function is the second thermoplastic resin interlayer.

3. The laminated glass according to claim 2,
wherein fine particles with a particle size of not more than 0.2 μm and having the heat shielding function are dispersed in the second thermoplastic resin interlayer.

4. The laminated glass according to claim 3,
wherein the fine particles comprise at least one selected from ITO and hexaboride.

5. The laminated glass according to claim 1,
wherein the interlayer portion comprises a first thermoplastic resin interlayer, the heat reflecting film, and a second thermoplastic resin interlayer; and
wherein the film having the heat shielding function is arranged between the second thermoplastic resin interlayer and the second glass sheet.

6. The laminated glass according to claim 5,
wherein the film having the heat shielding function is an application film containing fine particles of at least one selected from hexaboride and ITO; and
wherein the particle size of the fine particles is not more than 0.2 μm.

7. The laminated glass according to claim 5,
wherein the film having the heat shielding function is an ITO thin film.

8. The laminated glass according to claim 1,
wherein the heat absorption of the first glass sheet is equal to or smaller than the heat absorption of the second glass sheet.

9. The laminated glass according to claim 8,
wherein the heat absorption of the first glass sheet is smaller than the heat absorption of the second glass sheet.

10. The laminated glass according to claim 1,
wherein the laminated glass is bent to have a convex surface and a concave surface;
wherein the convex surface is formed by the first glass sheet and the concave surface is formed by the second glass sheet.
